(19) United States
(12) Patent Application Publication
(10) Pub. No.: US 2018/0044519 A1
(43) Pub. Date: Feb. 15, 2018

(54) POLYAMIDE 6,6 RESIN COMPOSITION HAVING TOUGHNESS, ABRASION RESISTANCE AND FRICTIONAL RESISTANCE

(71) Applicant: Hyundai Motor Company, Seoul (KR)

(72) Inventors: Jee Young YOUN, lncheon (KR); Bong Joo PARK, Goyang-si (KR); Kwang Hae NOH, Seongnam-si (KR)

(73) Assignee: Hyundai Motor Company, Seoul (KR)

(21) Appl. No.: 15/392,915

(22) Filed: Dec. 28, 2016

(30) Foreign Application Priority Data
Aug. 10, 2016 (KR) 10-2016-0101740

(51) Int. Cl. C08L 77/06; F16H 55/22; F16H 55/06

(52) U.S. Cl. CPC C08L 77/06; F16H 55/06; F16H 55/22; C08L 2205/24; C08L 2205/03; C08L 2201/08

(57) ABSTRACT

A polyamide 6,6 resin composition having improved toughness, abrasion resistance and frictional resistance is provided herein. The polyamide 6,6 resin composition comprises a graft copolymer of polyethylene and maleic anhydride, layered nanoclay, and a nucleating agent with a predetermined composition ratio in a base resin of polyamide 6,6 having ultra high viscosity. The polyamide 6,6 resin composition has properties of tensile strength (ISO527) of 83 Mpa or greater, elongation at break (ISO527) of 30% or greater, a kinematic friction coefficient of steel to metal measured by a ring-on-ring friction and abrasion tester of 0.30 or less, and a specific abrasion amount of 0.020 mm³/Kgf·km or less. The resin composition is useful as a worm gear for a motor-driven power steering device.

### CROSS-REFERENCE TO RELATED APPLICATION

This application claims under 35 U.S.C. § 119(a) the benefit of Korean Patent Application No. 10-2016-0101740, filed on Aug. 10, 2016, the entire contents of which are incorporated herein by reference for all purposes.

### BACKGROUND

### Technical Field

The present disclosure relates to a polyamide 6,6 resin composition with improved toughness, abrasion resistance and frictional resistance simultaneously. In this composition that has ultra high viscosity, a graft copolymer of polyethylene and maleic anhydride, layered nanoclay, and a nucleating agent are included at a predetermined composition ratio.

### Background Art

A motor-driven power steering (MDPS) worm gear is a device of transferring power of a motor to wheels when a steering wheel is turned. A plastic-made worm gear continuously receives high load and friction force which are transferred from a metal worm gear and thus requires high elongation and strength, and excellent friction to metal. As a gear material, a polyamide resin is mainly used. The tensile elongation of polyamide resin is excellent, however its tensile strength and friction to metal are insufficient. Thus, there is a problem of breakage, depression due to friction, or the like with polyamide resin-made worm gears.

In a design of a polymer complex material which is useful as a worm gear material, various techniques for improving strength and abrasion resistance of polyamide 6,6 have been developed. For example, a method of depositing a film having high durability on a surface, a method of improving durability by using grease, and the like are known. However, these techniques do not improve the polymer itself as a raw material and thus cannot be seen as a fundamental solution.

As a method for improving properties of the polyamide resin itself, research on development of additives has been continued. For instance, when an organic anti-abrasion additive is used, elongation is increased, but the strength deteriorates. When a general inorganic additive is used, tensile elongation deteriorates and toughness is decreased, and thus breakage is increased.

Research to improve impact strength and tensile strength by blending a polyamide resin and a polyolefin resin has progressed, but the friction characteristic to metal is poor and thus there are issues with using this material as a worm gear material.

Therefore, development of polyamide materials that improve toughness, friction resistance, and abrasion resistance is required.

The above information disclosed in this Background section is only for enhancement of understanding of the background of the invention and therefore it may include information that does not form the prior art that is already known in this country to a person of ordinary skill in the art.

### SUMMARY OF THE DISCLOSURE

The present invention has been made in an effort to solve the above-described problems associated with prior art.

The present invention has been made in an effort to provide a novel polyamide resin composition with excellent toughness, abrasion resistance and frictional resistance simultaneously by using polyamide 6,6 having ultra high viscosity as a base resin.

The present invention has also been made in an effort to provide a worm gear for a motor-driven power steering device manufactured by forming the polyamide resin composition.

In one aspect, the present invention provides a polyamide 6,6 resin composition comprising a) 100 parts by weight of ultra high viscosity polyamide 6,6 in which relative viscosity measured by ASTM D789 is 150 or greater, b) about 1 part to 3 parts by weight of a graft copolymer of polyethylene and maleic anhydride, c) about 0.5 part to about 3 parts by weight of layered nanoclay, and d) about 0.1 part to about 1 part by weight of a nucleating agent.

In another aspect, the present invention provides a worm gear for a motor-driven power steering device manufactured by forming the polyamide 6,6 resin composition.

The polyamide 6,6 resin composition according to the present invention has tensile strength (ISO527) of about 83 Mpa or greater, elongation at break (ISO527) of 30% or greater, a kinematic friction coefficient of steel to metal measured by a ring-on-ring friction and abrasion tester of about 0.30 or less, and a specific abrasion amount of about 0.020 mm³/Kgf·km or less. That is, the polyamide 6,6 resin composition according to the present invention has excellent toughness, friction resistance, and abrasion resistance.

Therefore, the polyamide 6,6 resin composition according to the present invention is useful as a worm gear material for a motor-driven power steering device.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a schematic diagram illustrating a testing device used for measuring friction resistance and abrasion resistance of a polyamide 6,6 resin composition.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to a polyamide 6,6 resin composition having excellent toughness (desired toughness), friction resistance, and abrasion resistance simultaneously. The polyamide 6,6 resin composition of the present invention comprises a) ultra high viscosity polyamide 6,6 as a base resin, and b) a graft copolymer of polyethylene and maleic anhydride, c) layered nanoclay, and d) a nucleating agent as required components therein.

Respective components configuring the polyamide 6,6 resin composition of the present invention will be described below in more detail.

### Ultra High Viscosity Polyamide 6,6

In the present invention, polyamide 6,6 can be used as a base resin. In the present invention, polyamide 6,6 having ultra high viscosity is selected and used as the polyamide 6,6. The term “ultra high viscosity” means polyamide 6,6 in which relative viscosity measured by ASTM D789 is about 150 or greater, and particularly, polyamide 6,6 in which relative viscosity measured by ASTM D789 is about 150 to about 380 (e.g., about 150, 200, 250, 300, 350 or about 380). In the present invention, when the relative viscosity of polyamide 6,6 used as the base resin is less than 150, toughness of the resin composition is low and elongation at break may deteriorate. Accordingly, in order to reinforce the toughness of the resin composition, the polyamide 6,6 having ultra high viscosity may be used.

### Graft Copolymer of Polyethylene and Maleic Anhydride

In the resin composition of the present invention, a graft copolymer of polyethylene and maleic anhydride (hereinafter, referred to as ‘PE-g-MA’) can be included as a required component. The PE-g-MA is used for reinforcing a weak fraction characteristic of the polyamide 6,6 base resin.

As illustrated in Chemical Formula 1, the PE-g-MA has a structure in which maleic anhydride (MA) is copolymerized in some ethylene repeating units in a polyethylene skeleton, and a copolymerization ratio of MA is a range of from about 0.5 wt % to about 3.5 wt % (e.g., about 0.5 wt %, 1 wt %, 1.5 wt %, 2 wt %, 2.5 wt %, 3 wt %, or about 3.5 wt %) to a weight of polyethylene.

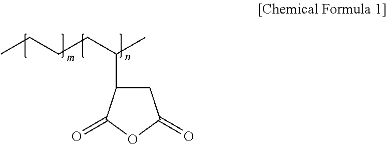

in Chemical Formula 1, m represents the number of moles of ethylene repeating units and n represents the number of moles of ethylene repeating units to which MA is bonded

The PE-g-MA included in the resin composition of the present invention improves a friction characteristic of polyamide 6,6 because a carboxylic group (—COOH) of the MA is amide-bonded with a terminal amine group (—NH₂) of the polyamide 6,6 used as the base resin.

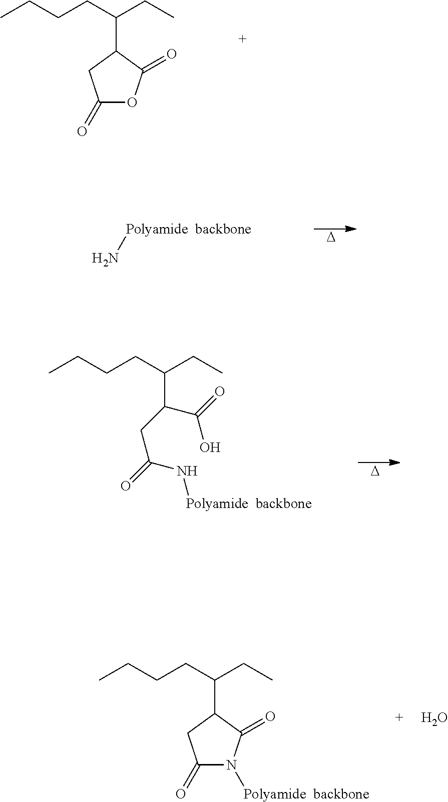

As a modified polyolefin resin in which the MA is copolymerized, EPDM-g-MA, SEBS-g-MA, and the like in addition to the PE-g-MA are known. The present invention is based, in part, on the discovery that the PE-g-MA in the modified polyolefin resin was effective to improve a friction characteristic of the ultra high viscosity polyamide 6,6 and further, solved the problem of deterioration of tensile strength caused by adding the modified polyolefin resin. Accordingly, in order to improve the friction characteristic of the polyamide 6,6 having the ultra high viscosity and minimize the deterioration of tensile strength, it is preferred that the PE-g-MA is selected and used as the modified polyolefin resin.

The PE-g-MA may be used in a range of about 1 part to about 3 parts by weight (e.g, about 1 part, 2 parts, or about 3 parts by weight) based on 100 parts by weight of the polyamide 6,6 used as the base resin. When the content of PE-g-MA is less than 1 part by weight, it is difficult to expect a desired effect of improving the friction characteristic of the polyamide 6,6 having the ultra high viscosity and when the content of PE-g-MA is greater than 3 parts by weight, there is a problem in that the tensile strength of the resin composition is largely reduced.

Layered Nanoclay

The resin composition of the present invention includes layered nanoclay in order to improve abrasion resistance by enhancing surface hardness.

The term “nanoclay” is a nano composite of a layered clay compound and generally prepared by releasing and dispersing the layered clay compound in a polymer material as an organic matrix with a nanoscale. The layered clay compound may be at least one selected from the group consisting of montmorillonite, bentonite, mica, kaolinite, hectorite, fluorohectorite, saponite, beidelite, nontronite, stevensite, vermiculite, hallosite, volkonskoite, suconite, magadite, and kenyalite. The layered clay compound can have a particle size of less than about 10 μm (e.g., about 9.7 μm, about 9 μm, 8 μm, 7 μm, 6 μm, 5 μm, 4 μm, 3 μm, 2 μm, about 1 μm, or less) and particularly, may use bentonite.

Generally, in order to improve the surface hardness, wollastonite which is an acicular inorganic material is also added. However, when the acicular inorganic material is added in the resin composition of the present invention, there is a problem in that the elongation of the resin composition is reduced. Accordingly, in the resin composition of the present invention, as the inorganic material that improves abrasion resistance and minimizes deterioration of elongation by increasing the surface hardness of the polyamide 6,6 having ultra high viscosity, layered nanoclay may be used. Further, only a small amount of nanoclay is added unlike other inorganic fillers to improve abrasion resistance and dose not adversely affect elongation of the resin, thereby maintaining toughness.

The nanoclay may be used in a range of from about 0.5 part to about 3 parts by weight (e.g., about 0.5 part, 1 part, 1.5 parts, 2 parts, 2.5 parts, or 3 parts by weight) based on 100 parts by weight of the polyamide 6,6 used as the base resin. When the content of nanoclay is less than 0.5 part by weight, it is difficult to expect an effect of improving abrasion resistance and when the content is greater than 3 parts by weight, there is a problem in that the elongation of the resin composition is largely reduced.

Nucleating Agent

In the resin composition of the present invention, in order to improve tensile strength by increasing crystallinity, a nucleating agent is added as a required component.

The nucleating agent may use an inorganic nucleating agent, an organic nucleating agent, or an organic/inorganic complex nucleating agent. In detail, as the inorganic nucleating agent, talc in a magnesium silicate form may be included, and as the organic nucleating agent, NA-11, NA-21, NA-05 product series of Adeka Corporation, Bruggolen P22 of Brueggemann Corporation, and the like may be included. As the organic/inorganic complex nucleating agent, Bruggolen P250 and the like may be included. In the present invention, selection of the nucleating agent is not particularly limited thereto. In some embodiments, the nucleating agent is talc in a magnesium silicate form having a plate structure. Such a nucleating agent can enhance crystallinity of the polyamide 6,6 resin.

The nucleating agent may be used in a range of 0.1 to 1 part by weight (e.g., about 0.1 part, 0.2 part, 0.3 part, 0.4 part, 0.5 part, 0.6 part, 0.7 part, 0.8 part, 0.9 part, or about 1 part by weight) based on 100 parts by weight of the polyamide 6,6 used as the base resin. When the content of nucleating agent is less than 0.1 part by weight, it is difficult to expect an effect of improving crystallinity and when the content is greater than 1 parts by weight, there is a problem in that the toughness of the resin composition is largely reduced.

Other Additives

In the resin composition of the present invention, at least one additive selected from the group consisting of a lubricant and an antioxidant may be further included.

The lubricant may be used for improving operability of metering of the resin composition and a release property of a molded article. The lubricant may include at least one selected from the group consisting of a LDPE wax type, an acrylic ester type, a Montan wax type, a Lico wax type, a metal stearate type, and the like. In the present invention, selection of the lubricant is not particularly limited thereto.

The lubricant may be used in a range of about 0.1 part to about 1 part by weight (e.g., about 0.1 part, 0.2 part, 0.3 part, 0.4 part, 0.5 part, 0.6 part, 0.7 part, 0.8 part, 0.9 part, or about 1 part by weight) based on 100 parts by weight of the polyamide 6,6 used as the base resin. When the content of lubricant is less than 0.1 part by weight, it is difficult to expect an adding effect, and when the content thereof is greater than 1 part by weight, deterioration of a property of the resin composition and appearance defects due to gas generation may occur.

The antioxidant may be used for suppressing pyrolysis or oxidation reaction of the resin composition. The antioxidant may include at least one selected from the group consisting of phenol-type primary antioxidants, phosphite-type secondary antioxidants, sulfur-based antioxidants in thioester type, and the like. In the present invention, selection of the antioxidant is not particularly limited thereto.

The antioxidant may be used in a range of about 0.1 part to 1 part by weight (e.g., about 0.1 part, 0.2 part, 0.3 part, 0.4 part, 0.5 part, 0.6 part, 0.7 part, 0.8 part, 0.9 part, or about 1 part by weight) based on 100 parts by weight of the polyamide 6,6 used as the base resin. When the content of antioxidant is less than 0.1 part by weight, it is difficult to expect an adding effect, and when the content thereof is greater than 1 part by weight, appearance defects due to gas generation may occur.

The polyamide 6,6 resin composition that satisfies the components and the composite ratio described above has properties of tensile strength (ISO527) of 83 Mpa or greater, elongation at break (ISO527) of about 30% or greater (e.g., about 30%, about 40%, about 50%, about 60%, or greater), a kinematic friction coefficient of steel to metal measured by a ring-on-ring friction and abrasion tester of about 0.30 or less (e.g., about 0.30, 0.25, 0.2, 0.15, 0.1, or less), and a specific abrasion amount of about 0.020 mm³/Kgf·km or less (e.g., about 0.020 mm³/Kgf·km, 0.016 mm³/Kgf·km, 0.014 mm³/Kgf·km, or less). That is, the polyamide 6,6 resin composition of the present invention has excellent tensile strength, elongation at break, friction resistance, and abrasion resistance simultaneously and thus is useful as a worm gear material for a motor-driven power steering device (MDPS).

As described above, the present invention will be described in more detail based on the following Examples and the present invention is not limited thereto.

### EXAMPLES

The following examples illustrate the invention and are not intended to limit the same.

### Examples 1 to 3 and Comparative Examples 1 to 8

### Preparation of Polyamide 6,6 Resin Composition

Respective components were mixed with a composition ratio listed in the following Table 1 to prepare a polyamide 6,6 resin composition.

<Used Components>

Ultra high viscosity polyamide 6,6: Relative viscosity of 240 measured by ASTM D789, Invista HV240A NC01

High viscosity polyamide 6,6 (high viscosity): Relative viscosity of 125 measured by ASTM D789, Invista HV125A NC01

PE-g-MA: Partially Polarized PE, GR-216 (product of Dow Chemical Corporation), m.p. 145° C., specific gravity of 0.88, MI 1.3 g/10 min

EPDM-g-MA: Partially Polarized EPDM, 416D (product of Dupont Corporation), m.p 43° C., specific gravity of 0.87, MI 23 g/10 min

S-EBS-g-MA: Partially Polarized S-EBS, FG1901 (product of Kraton Corporation), MI 14 to 28 g/10 min

Nanoclay: Layered bentonite, Cloisite 20 (product of BYK Corporation), d₅₀<10 μm, Bentonite salt of bis(hydrogenated tallow alkyl)dimethyl chlorides

Wollastonite: Wollastonite, average size of 7 μm, specific gravity of 2.9, MOHS hardness of 4.5, surface area of 2.9 m²/g

Nucleating agent: Plate type talc, Size 3.5 to 0.5 μm, KC-5000 (product of Koch Corporation)

Lubricant: LDPE wax type, L-C102N (product of Lion Chemtech Corporation)

Antioxidant: Phenol-based primary antioxidant, Songnox 1098 (product of Songwon Corporation)

TABLE 1

| Classification (part by | | Example | | | Comparative Example | | | | | | | |
|---|---|---|---|---|---|---|---|---|---|---|---|---|
| weight) | | 1 | 2 | 3 | 1 | 2 | 3 | 4 | 5 | 6 | 7 | 8 |
| Base resin | Ultra high | 100 | 100 | 100 | — | 100 | 100 | 100 | 100 | 100 | 100 | 100 |
| | viscosity | | | | | | | | | | | |
| | PA66 | | | | | | | | | | | |
| | High viscosity | — | — | — | 100 | — | — | — | — | — | — | — |
| | PA66 | | | | | | | | | | | |
| Modified | PE-g-MA | 1 | 2 | 2 | 1 | 5 | 2 | — | — | 2 | — | — |
| olefin | EPDM-g-MA | — | — | — | — | — | — | — | — | — | 2 | — |
| | SEBS-g-MA | — | — | — | — | — | — | — | — | — | — | 2 |
| Inorganic | Nanoclay | 2 | 2 | 3 | 2 | 2 | 5 | — | — | — | 2 | 2 |
| filler | Wollastonite | — | — | — | — | — | — | — | — | 3 | — | — |
| Nucleating | Plate type talc | 0.2 | 0.2 | 0.2 | 0.2 | 0.2 | 0.2 | — | 0.2 | 0.2 | 0.2 | 0.2 |
| agent | | | | | | | | | | | | |

| | | | | | | | | | | | |
|---|---|---|---|---|---|---|---|---|---|---|---|
| Lubricant | 0.3 | 0.3 | 0.3 | 0.3 | 0.3 | 0.3 | — | 0.3 | 0.3 | 0.3 | 0.3 |
| Antioxidant | 0.3 | 0.3 | 0.3 | 0.3 | 0.3 | 0.3 | — | 0.3 | 0.3 | 0.3 | 0.3 |

### TEST EXAMPLES

### Measurement of Properties of Polyamide 6,6 Resin Composition

A polyamide 6,6 resin composition prepared in Examples 1 to 3 and Comparative Examples 1 to 8 was melted and milled in a biaxial melting extruder heated at 250° C. to prepare a pellet. Thereafter, the pellet was dried for 4 hours at 100° C. and then a specimen was prepared by using a screw extruder heated at 250° C. With respect to the prepared specimen, tensile strength and elongation at break were measured based on an ISO527 test method.

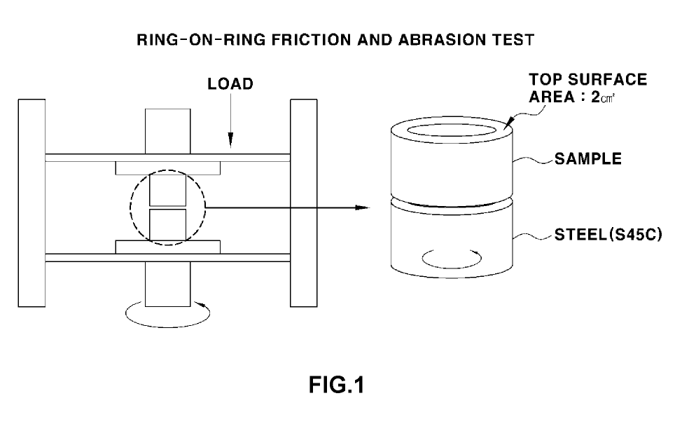

With respect to the polyamide 6,6 resin composition prepared in Examples 1 to 3 and Comparative Examples 1 to 8, in order to evaluate friction and abrasion, properties were measured according to a JIS K7218 method by using a ring-on-ring friction and abrasion tester illustrated in FIG. 1. That is, while a ring-shaped specimen was mounted on the tester and rotated at an evaluation velocity of 100 mm/sec with a load of 120 N, an abrasion amount was evaluated for 60 minutes and friction and abrasion characteristics were analyzed. As relative metal, steel (S45C) was used.

A result of evaluating the properties measured by the Test Example method was listed in the following Table 2.

TABLE 2

| | Example | | | Comparative Example | | | | | | | |
|---|---|---|---|---|---|---|---|---|---|---|---|
| Unit | 1 | 2 | 3 | 1 | 2 | 3 | 4 | 5 | 6 | 7 | 8 |
| Tensile | 85 | 83 | 84 | 88 | 79 | 84 | 79 | 85 | 86 | 78 | 76 |
| strength | | | | | | | | | | | |
| (Mpa) | | | | | | | | | | | |
| Elongation at | 35 | 37 | 35 | 20 | 38 | 20 | 32 | 31 | 10 | 30 | 27 |
| break | | | | | | | | | | | |
| (%) | | | | | | | | | | | |
| Kinematic | 0.28 | 0.25 | 0.22 | 0.29 | 0.25 | 0.19 | 0.43 | 0.42 | 0.39 | 0.64 | 0.69 |
| friction | | | | | | | | | | | |
| coefficient | | | | | | | | | | | |
| Specific | 0.019 | 0.018 | 0.013 | 0.020 | 0.016 | 0.012 | 0.084 | 0.081 | 0.078 | 0.095 | 0.101 |
| abrasion | | | | | | | | | | | |
| amount | | | | | | | | | | | |
| (mm³/Kgf · km) | | | | | | | | | | | |

According to the result in Table 2, it was evaluated that the polyamide 6,6 resin composition prepared in Examples 1 to 3 had tensile strength (ISO527) of 83 Mpa or greater, elongation at break (ISO527) of 30% or greater, a kinematic friction coefficient of steel to metal measured by a ring-on-ring friction and abrasion tester of 0.30 or less, and a specific abrasion amount of 0.020 mm³/Kgf·km or less. That is, it can be seen that the polyamide 6,6 resin composition of the present invention has excellent tensile strength, elongation at break, friction resistance, and abrasion resistance and thus is useful as a worm gear material for a motor-driven power steering device (MDPS).

Meanwhile, Comparative Example 1 is a resin composition including polyamide 6,6 having high viscosity (relative viscosity of 125) as the base resin and it can be seen that elongation is low as compared with the composition including polyamide 6,6 having ultra high viscosity of Example 1. Comparative Example 2 is a resin composition including a large amount of PE-g-MA and it can be seen that the tensile strength deteriorates. Comparative Example 3 is a composition including a large amount of layered nanoclay and it can be seen that an effect of improving friction resistance and abrasion resistance may be obtained, but elongation is low. Comparative Example 4 is a resin composition including polyamide 6,6 of high viscosity (relative viscosity 125) without including an additive and it can be seen that tensile strength, friction resistance, and abrasion resistance are poor. Comparative Example 5 is a resin composition including polyamide 6,6 of high viscosity (relative viscosity 125) without including PE-g-MA and nanoclay and it can be seen that tensile strength and elongation are excellent, but friction resistance and abrasion resistance are poor. Comparative Example 6 is a composition including acicular wollastonite instead of layered nanoclay in the composition of Example 2 and it can be seen that elongation, friction resistance, and abrasion resistance are poor. Further, Comparative Examples 7 and 8 are compositions including modified olefin of EPDM-g-MA or SEBS-g-MA instead of PE-g-MA in the composition of Example 2 and it can be seen that tensile strength, friction resistance, and abrasion resistance are poor. In Comparative Examples 7 and 8, it can be seen that in the composition including SEBS-g-MA, elongation is low and tensile strength, friction resistance, and abrasion resistance are also low. As a result, it can be seen that in the resin composition including polyamide 6,6 having ultra high viscosity, tensile strength, elongation, friction resistance, and abrasion resistance are significantly changed by selection of modified olefin.

According to the result of Test Example, in the resin composition including polyamide 6,6 having ultra high viscosity, in order to simultaneously satisfy tensile strength, friction resistance, and abrasion resistance, it can be seen that it is very important to select the PE-g-MA and the layered nanoclay.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polyamide 6,6 resin composition, comprising:
a) about 100 parts by weight of an ultra-high viscosity polyamide 6,6 resin having relative viscosity of about 150 or greater measured by ASTM D789;
b) about 1 to about 3 parts by weight of a graft copolymer of polyethylene and maleic anhydride;
c) about 0.5 to about 3 parts by weight of layered nanoclay; and
d) about 0.1 to about 1 part by weight of a nucleating agent.

2. The polyamide 6,6 resin composition of claim 1, wherein the polyamide 6,6 resin has ultra high viscosity, in which relative viscosity measured by ASTM D789 is from about 150 to about 380.

3. The polyamide 6,6 resin composition of claim 1, wherein in the graft copolymer, from about 0.5 wt % to about 3.5 wt % of maleic anhydride to a weight of polyethylene is graft-copolymerized.

4. The polyamide 6,6 resin composition of claim 1, wherein the layered nanoclay is at least one selected from the group consisting of montmorillonite, bentonite, mica, kaolinite, hectorite, fluorohectorite, saponite, beidelite, nontronite, stevensite, vermiculite, hallosite, volkonskoite, suconite, magadite, and kenyalite.

5. The polyamide 6,6 resin composition of claim 1, wherein the nucleating agent is an inorganic nucleating agent, an organic nucleating agent, or an organic/inorganic complex nucleating agent.

6. The polyamide 6,6 resin composition of claim 5, wherein the nucleating agent is talc in a magnesium silicate form.

7. The polyamide 6,6 resin composition of claim 1, further comprising
at least one additive selected from the group consisting of a lubricant and an antioxidant.

8. The polyamide 6,6 resin composition of claim 7, wherein the lubricant is low-density polyethylene (LDPE) wax.

9. The polyamide 6,6 resin composition of claim 7, wherein the antioxidant is a phenol-based antioxidant.

10. The polyamide 6,6 resin composition of claim 1, wherein the polyamide 6,6 resin composition has properties of tensile strength (ISO527) of about 83 Mpa or greater, elongation at break (ISO527) of about 30% or greater, a kinematic friction coefficient of steel to metal measured by a ring-on-ring friction and abrasion tester of about 0.30 or less, and a specific abrasion amount of about 0.020 mm³/Kgf·km or less.

11. A vehicle worm gear manufactured by forming the polyamide 6,6 resin composition of claim 1.
